(19) United States
(12) Patent Application Publication
(10) Pub. No.: US 2023/0281433 A1
(43) Pub. Date: Sep. 7, 2023

(54) COMPILATION OF NEURAL NETWORKS WITH DYNAMIC SHAPES OF TENSORS

(71) Applicant: NEC Laboratories Europe GmbH, Heidelberg (DE)

(72) Inventor: Nicolas Weber, Heidelberg (DE)

(21) Appl. No.: 17/728,999

(22) Filed: Apr. 26, 2022

Related U.S. Application Data
(60) Provisional application No. 63/317,096, filed on Mar. 7, 2022.

(51) Int. Cl. G06N 3/063; G06N 3/04

(52) U.S. Cl. CPC G06N 3/063; G06N 3/04

(57) ABSTRACT

A computer-implemented method for compiling a neural network with tensors having dynamic shapes includes parsing the neural network using a set of global virtual dimension identifications (IDs) that define the dynamic shapes of one or more of the tensors of the neural network. The method further includes performing shape checks while building a computation graph using the set of global virtual dimension IDs, and generating a runtime code of the neural network based on the computation graph.

### CROSS-REFERENCE TO PRIOR APPLICATIONS

Priority is claimed to U.S. Patent Application No. 63/317,096, filed on Mar. 7, 2022, the entire disclosure of which is hereby incorporated by reference herein.

### FIELD

Embodiments of the present disclosure relate to parsing and compilation of neural network functions with dynamic shapes of tensors.

### BACKGROUND

In the artificial intelligence (AI) or machine learning field, a neural network (NN) is a specialty computing system inspired by the biological neural networks that constitute human brains. A neural network computing system is generally based on modeling a collection of connected nodes, which loosely mimic the neurons in a biological brain. Each connection (also called edges), like synapses of a biological brain, may transmit a signal between connected nodes. A node that receives a signal processes it and can in turn send a signal to those nodes connected to it. The “signal” at an input connection may be a real number, and the “output” of each node may be computed by some non-linear function of the sum of its inputs. Nodes may have a threshold such that a signal is sent only if the aggregate signal crosses that threshold.

Nodes can be aggregated into layers of the neural network. Different layers may perform different transformations on their inputs. Signals travel from the first layer (the input layer) to the last layer (the output layer). Neural networks “learn” to perform tasks by considering examples. Nodes and connections typically have a “weight” that adjusts as learning proceeds. The weight increases or decreases the “strength” of the signal at a connection.

Neural networks may use tensors to represent data in the neural network. For example, the inputs, outputs, and transformations within a neural network can be represented using tensors. Tensors can include scalars, vectors, matrices, and nd-arrays, and the like. The concepts of rank, axes, and shape are example tensor attributes used in neural networks. These concepts build on one another starting with rank, then axes, and building up to shape. The rank of a tensor refers to the number of dimensions present within the tensor. For example, a rank-2 tensor means it is a matrix or a 2d-tensor, a rank-n tensor means it is a nd-array, and so on. An axis of a tensor is a specific dimension of a tensor. The length of each axis tells us how many elements exist along each axis. For example, if a 2d-tensor has a length of three along the first axis and a length of four along the second axis, the tensor would be a 3×4 matrix. The shape of a tensor refers to the length of each axis of the tensor.

Modern neural networks can make use of tensors with dynamic shapes. Dynamic tensor shapes can pose optimization problems for compilers. For example, it can be difficult to generate optimal code due to the unknown sizes of the tensor at compile time. The following references discusses some of the issues associated with dynamic tensor shapes, the entire contents of which are hereby incorporated by reference herein: [1] Haichen Shen, et al., “NIMBLE: EFFICIENTLY COMPILING DYNAMIC NEURAL NETWORKS FOR MODEL INFERENCE,” available at <<https://arxiv.org/abs/2006.03031>> (last accessed Mar. 3, 2022); [2] “ONNX Shape Inference”, available at <<github.com/onnx/onnx/blob/main/docs/ShapeInference.md>> (last accessed Mar. 3, 2022); [3] “ONNX Symbolic Shape Inference”, available at <<github.com/microsoft/onnxruntime/blob/master/onnxruntime/python/tools/symbolic_shape_infer.py#L1267>> (last accessed Mar. 3, 2022). Dynamic shapes may also be referred to as dynamic dimensions.

### SUMMARY

Embodiments of the present disclosure provide a computer-implemented method for compiling a neural network with tensors having dynamic shapes. The method includes parsing the neural network using a set of global virtual dimension identifications (IDs) that define the dynamic shapes of one or more of the tensors of the neural network. The method further includes performing shape checks while building a computation graph using the set of global virtual dimension IDs, and generating a runtime code of the neural network based on the computation graph.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a computation graph representation of dynamic shapes;

FIG. 2 is a flowchart illustrating a method for compiling a neural network with dynamic shapes for machine learning according to some embodiments; and

FIG. 3 is a block diagram of an exemplary processing system, which can be configured to perform the methods according to some embodiments.

### DETAILED DESCRIPTION

Dynamic shapes of tensors in neural networks and scientific computations are a convenient user feature, and are used in many frameworks and computation libraries. However, dynamic shapes of tensors can pose some optimization issues for compilers. They also can pose some issues for the execution of neural network functions.

For example, dynamic shapes of tensors can result in inefficient runtime code. Runtime code is a piece of code that implements portions of a programming language's execution model. Runtime systems, such as PyTorch, TensorFlow, Numpy, or ONNXruntime, can use arbitrary input shapes for their operations, e.g., C=A+B. Because these runtime systems rely on generic function implementations, they can be flexible. However, these runtime systems can suffer from performance penalties compared to compiler engines such as TVM, which can directly optimize the code for a fixed data shape. Compiling is the transformation from source code (human readable) into machine code (computer executable).

Consider the example function of C=A+B. Within a runtime system, this would be implemented as shown in Table 1 below.

TABLE 1

```
class Tensor:
    shape = [1, 2, 3, 4]
    dtype = float
    ptr = 0x123456789
def add(A: Tensor, B: Tensor): −> Tensor
  assert A.shape == B.shape
  C = new Tensor(A.shape, A.dtype)
  for i in range(prod(A.shape)):
      C[i] = A[i] + B[i]
  return C
```

In this example, the number of iterations for the loop (“for i in range (prod (A.shape))”) is unknown. Thus, the function can be compiled into multiple code paths and the best can be selected at runtime. In addition, the compiling would require checks that verify that the input shapes of A and B are identical.

In contrast, if the shape is statically defined at compile time, the code can be simplified as shown in Table 2 below.

TABLE 2

```
def add(A: Tensor, B: Tensor): −> Tensor
  C = new Tensor([2, 8], float)
  vector_add(C[0: 8], A[0: 8], B[0: 8])
  vector_add(C[8:16], A[8:16], B[8:16])
  return C
```

The code in Table 2 has no conditional code paths or any costly runtime checks, and thus can be significantly more efficient. Furthermore, it can directly unroll the loop into vector operations, as all information are known at compile time.

A disadvantage of the compiler approach is that it may be necessary to recompile the function whenever the shape of the input data changes. This is the case for compilers such as Torch JIT, TVM, NGraph and TensorRT. Although some compilers, such as TVM, have introduced the option to use dynamic shapes, those compilers can require significant runtime operations to handle dynamic shapes, and thus can incur significant performance penalties. See, e.g., “The performance degradation of VM runtime and Dynamic Shape support compared to Graph Runtime,” available at <<discuss.tvm.apache.org/t/vm-the-performance-degradation-of-vm-runtime-and-dynamic-shape-support-compared-to-graph-runtime/6076>> (last accessed Mar. 3, 2022), the entire contents of which is hereby incorporated by reference.

The same problem can arise for computing the output shape of a layer. Conventional methods cannot statically evaluate the dynamic shapes. Thus, a runtime code that computes the new shapes of the tensors may be needed every time a layer is executed. Because of this, it may be necessary to store additional information about the shapes of all input tensors when executing the neural network.

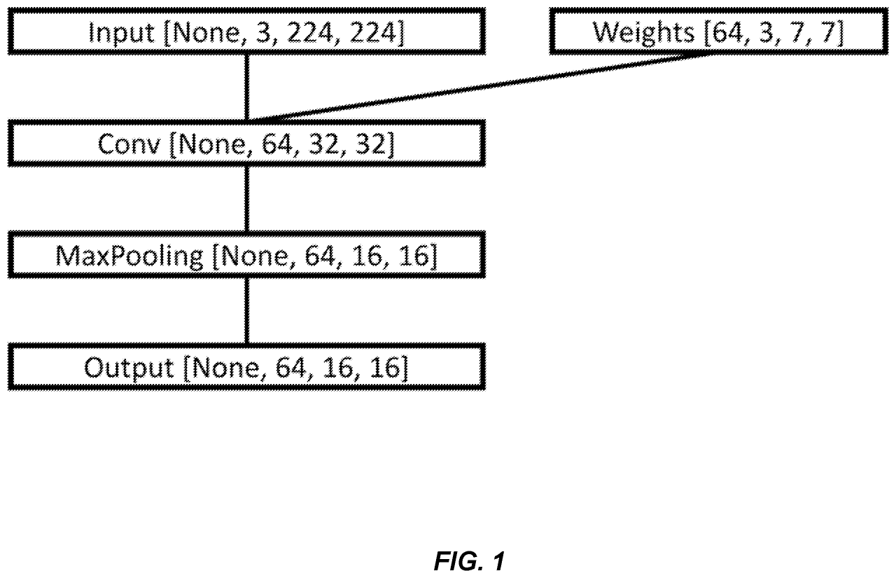

Another problem associated with dynamic tensors relates to the computation graph representation of dynamic shapes. Existing methods allow the user mark dynamic shapes as “Any” (TVM), “0” (PyTorch JIT) or “None” (TensorFlow Graph). This indicates that the size is runtime dependent. The neural network structure would be parsed resulting in a computation graph similar to that as shown in FIG. 1 (here, and in the following, TensorFlow notation is used). This method, however, can impose some problems, as discussed in the examples below.

For instance, in Tile/Repeat operations that duplicate data, (see ONNX—Operator Schema:Tile, available at <<github.com/onnx/onnx/blob/master/docs/Operators.mdkile>> (last accessed, Mar. 3, 2022), the entire contents of which are hereby incorporated by reference) a tensor of shape [2, 3] would be transformed with the factor [1, 2] into the shape [2, 6]. With a dynamic input shape of [2, None], this would be transformed into [2, None], which loses the information that the second dimension is duplicated.

As another example, in operations with multiple inputs (e.g., Add, Mul, Div, Sub, etc.), shapes would need to be identical. Thus, it may be required to add runtime checks in the final code to ensure that the shapes are identical. See, e.g., Roesch and Shen, “Extending TVM with Dynamic Execution,” available at <<tvmconforg/slides/2019/Jared-Roesch-Haichen-Shen-RelayVM.pdf>> (last accessed Mar. 3, 2022), the entire contents off which are hereby incorporated by reference herein (slides 12 and 15 of which discusses the problem and that it requires to add runtime checks in the final code).

As a further example, the Reshape/View operations allow to reshape a Tensor's data. See ONNX—Operator Schema:Reshape, available at <<github.com/onnx/onnx/blob/master/docs/Operators.md#Reshape>> (last accessed Mar. 3, 2022), the entire contents of which is hereby incorporated by reference herein. So a shape of [1, 2, 3, 4] can be reshaped to [2, 12]. However, the convention of Reshape can be somewhat restrictive, e.g., only allowing one summation dimension (−1), requiring not changing a dimension (0), or requiring providing the exact size (any positive integer value). Thus, if a tensor has a shape of [None, None, None, None], it may not be possible to change its shape to [None*None, None*None].

Accordingly, conventional methods cannot evaluate dynamic shapes at compile time efficiently, and may require introducing a substantial amount of runtime information and checks into the code to guarantee proper execution. Embodiments of the present disclosure provide methods that can extract more information when parsing the neural networks, which can allow statically evaluating tensor shapes and precomputing tensor shapes for dynamic shapes. These methods can reduce the necessary runtime overhead. For example, the methods can remove runtime shape checks by completing shape checks at compile time, and minimize maintenance of dynamic shape information at runtime.

As described above and below, embodiments of the present disclosure provide mechanisms and methods that improve computer systems and computer networks, including specialty machine learning computer systems and neural networks. For example, embodiments of the present disclosure can provide flexibility, usability, and efficiency by changing statically parsed neural network into dynamic shapes of tensors. Embodiments of the present disclosure can also enhance performance of the specialty machine learning computer systems and neural networks by performing tensor shape checks at compile time, resulting in minimal and more efficient runtime code. Embodiments of the present disclosure can also enhance performance and reduce memory consumption of specialty machine learning computers by reducing maintenance of dynamic shape information at runtime, as less information needs to be stored.

In a first aspect, the present disclosure provides a computer-implemented method for compiling a neural network with tensors having dynamic shapes. The method includes parsing the neural network using a set of global virtual dimension identifications (IDs) that define the dynamic shapes of one or more of the tensors of the neural network, performing shape checks while building a computation graph using the set of global virtual dimension IDs, and generating a runtime code of the neural network based on the computation graph.

In a second aspect, the present disclosure provides the method according to the first aspect, wherein parsing the neural network includes initializing the dynamic shapes of the one or more tensors with the set of global virtual dimension IDs.

In a third aspect, the present disclosure provides the method according to the first or second aspect, wherein parsing the neural network further includes precomputing reference values for a subset of the set of global virtual dimension IDs using stored static shapes.

In a fourth aspect, the present disclosure provides the method according to at least one of the above aspects, and the method further includes auto-tuning the neural network based on the reference values.

In a fifth aspect, the present disclosure provides the method according to at least one of the above aspects, wherein auto-tuning the neural network includes estimating the dynamic shapes of a subset of the one or more tensors based on the reference values.

In a sixth aspect, the present disclosure provides the method according to at least one of the above aspects, wherein performing shape checks includes removing a first subset of the set of global virtual dimension IDs from the neural network based on constraints of one or more operations in the computation graph.

In a seventh aspect, the present disclosure provides the method according to at least one of the above aspects, wherein values of a second subset of the set of global virtual dimension IDs that have not been removed are to be computed at runtime based on values extracted from input tensors of the neural network or from layers with dynamic output shape.

In an eighth aspect, the present disclosure provides the method according to at least one of the above aspects, wherein values of a second subset of the set of global virtual dimension IDs that have not been removed are to be computed at runtime based on values extracted from layers with dynamic output shape.

In a ninth aspect, the present disclosure provides the method according to at least one of the above aspects, wherein the computation graph comprises a tile/repeat operation.

In a tenth aspect, the present disclosure provides the method according to at least one of the above aspects, and the method further includes merging the tile/repeat operation in two or more layers of the neural network.

In an eleventh aspect, the present disclosure provides the method according to at least one of the above aspects, wherein the computation graph comprises a reshape operation.

In a twelfth aspect, the present disclosure provides the method according to at least one of the above aspects, wherein the neural network is configured to perform real time video processing.

In a thirteenth aspect, the present disclosure provides the method according to at least one of the above aspects, wherein the real time video processing dynamically adapts the number of frames being processed simultaneously.

In a fourteen aspect, the present disclosure provides a system for compiling a neural network with tensors having dynamic shape. The system includes one or more hardware processors which, alone or in combination, are configured to provide for execution of the following steps: parsing the neural network using a set of global virtual dimension identifications (IDs) that define the dynamic shapes of one or more of the tensors of the neural network, performing shape checks while building a computation graph using the set of global virtual dimension IDs, and generating a runtime code of the neural network based on the computation graph. The system according to the fourteenth aspect may further be configured according to any one of the second through thirteenth aspects.

In a fifteenth aspect, the present disclosure provides a tangible, non-transitory computer-readable medium having instructions thereon which, upon being executed by one or more hardware processors, alone or in combination, provide for execution of the method according to one or more of the firth through thirteenth aspects.

### Compile Time Optimizations

Embodiments of the present disclosure can provide mechanisms for representing dynamic shapes in a computation graph. In conventional methods, dynamic shapes can be represented by a singular value (e.g., 0, Any, or None). When parsing a neural network, conventional methods such as PyTorch's TorchScript, ONNX, Keras, or TensorFlow Graph may require the user to provide the shape of all input tensors. This shape value would be replaced by the dynamic shape representation.

According to some embodiments, dynamic shapes are represented as a scalar factor and a set of virtual dimension IDs (i.e. #0, #1, #2, . . . ). The virtual dimension IDs can be unique for the entire neural network, and are referred to as global virtual dimension IDs. Table 3 shows an example.

TABLE 3

```
class Dim:
  scalar = 1
  vdims = [#0, #1]
  def _{——}init_{——}(self, scalar=1, vdims=[ ]):
    self.scalar = scalar
    self.vdims = vdims
```

When parsing the neural network, the shapes of the inputs are initialized with the global virtual dimension IDs. The static shape that is provided by the computation graph can be used to initialize a reference size for each of the global virtual dimension IDs. Table 4 shows an example.

TABLE 4

| input_1[#0, #1, #2, #3] | = Input([3, 5, 2, 1]) |
|---|---|
| input_2 [#4, #5] | = Input([10, 12]) |
| global_vdims | = {#0: 3, #1: 5, #2: 2, #3: 1, #4: 10, #5: 12} |

Parameters, buffers, and generative functions—such as Range or Random (except if the shape of the generative function depends on the shape of a tensor, e.g., torch.zeros_like)—may not get dynamic shapes assigned because they are model specific and may not be dynamically changed by any runtime information.

The examples below illustrate how the methods can be implemented according to some embodiments.

### Tile Operation

In the Tile operation, the scalar value is used within the definition of the dimensions. For example, if an input shape is [Dim (2, [ ]), Dim (1, [#1])], then the output shape will be [Dim (2, [ ]), Dim (2, [#1])] when using the tile factor [1, 2]. As can be seen, the scalar size of the dimension has doubled. In contrast, this information can be lost in conventional methods.

For example, the ONNX Symbolic Shape Inference (OSSI, available at <<github.com/onnx/onnx/blob/main/docs/ShapeInference.md>> (last accessed Mar. 3, 2022), the entire contents of which are hereby incorporated by reference herein) uses a Python based symbolic library to enable such computations. But it stores the computation as “N*2.” Also, some conventional methods can support only one dynamic size per dimension, e.g., so called “param” (see: <<github.com/onnx/onnx/blob/60531231618431a480f2b7b18ee94763829b2c3e/onnx/defs/sh ape inference.h#L600>> (last accessed Mar. 3, 2022), the entire contents of which are hereby incorporated by reference herein). In contrast, embodiments of the present disclosure can support multiple dynamic sizes per dimension.

Operations with Multiple Inputs

In operations with multiple inputs, global virtual dimension IDs of the inputs can be mapped. For instance, consider the following example:

C[?,?,?]=A[#0,#1,#2]+B[#3,#4,#5].

This can require that #0==#3, #1 #4, and #2 #5. Thus, all occurrences of #3 can be replaced with #0, all occurrences of #4 can be replaced with #1, and occurrences of #5 can be replaced with #2, in the entire network. This would result in:

C[#0,#1,#2]=A[#0,#1,#2]+B[#0,#1,#2].

In the case where:

C[?,?,?]=A[#0,#1,#2]+B[#3,7,3],

it can require that #1==7 and #2==3. Thus, global virtual dimension IDs #1 and #2 can be removed from the neural network, as the computation enforces the sizes of these dimensions, resulting in:

C[#0,7,3]=A[#0,7,3]+B[#0,7,3].

This situation can occur, for example, in all layers that apply model parameters to the data (e.g. in Matrix Multiplications) where O=I**W, and W has fixed dimensions for the channels. Whenever a dynamic shape is removed, the value that replaces it can be verified to ensure it matches with the value stored in global_vdims to ensure that no errors occur when replacing it.

Some functions support broadcasting, so that one tensor can have an arbitrary size, when the other tensor has size 1. (see, e.g., <<pytorch.org/docs/stable/notes/broadcasting.html#broadcasting-semantics>> (last accessed, Mar. 3, 2022), the entire contents of which are hereby incorporated by reference herein). According to some embodiments, this can be implemented by keeping the dynamic shapes #3, #4, #5 in place and adding constraints such as (#0 #3 or #0==1 or #3==1).

In contrast, conventional methods, such as Zhu et al., “DISC: A Dynamic Shape Compiler for Machine Learning Workloads,” (available at <<arxiv.org/pdf/2103.05288.pdf>> (last accessed Mar. 3, 2022), the entire contents of which is hereby incorporated by reference herein) only works per layer, and not globally on the entire neural network. If Zhu encounters an ADD, SUB, MUL or similar operation, it does not globally propagate to an entire graph a mapping that the dynamic shapes of the particular input and output tensors match, which reduces its opportunity for optimization. Zhu, in Section 4.3, states that it poses a problem for loop fusing. It suggests to instead use flexible loop fusing patterns to work better with wide ranges of tensor shapes. OSSI has so called “merging,” that would not replace #3, #4, #5 in the entire graph (considering the example above), but start from a currently processed layer. So OSSI does not remember the constraints #0==#3, etc. OSSI, unlike in embodiments of the present disclosure, is unable to check for consistency, e.g., because OSSI does not “know” that #3 needs to be identical to #0.

### Reshape/View Operation

The Reshape/View operation may be a more complicated layer to process with dynamic shapes. The user usually provides a predefined shape to the operations, e.g., [−1, 3, 224, 224]. When the input shape would be [#0, #1, #2,], the dynamic shapes #0, #1, and #2 would not be associated with any of the user defined fixed sizes. To solve this problem, multiple methods may be used according to various embodiments, as illustrated in Example A and Example B below.

### Example A

For example, when parsing, users can write the code as:

reshape(x,[−1,x.shape[1],x.shape[2]*x.shape[3]).

In some embodiments, the multiplication and division operators on the dynamic shapes can be defined as in Table 5:

TABLE 5

```
class Dim:
  ...
  def _{——}mul_{——}(A, B):
    return Dim(A.scalar * B.scalar, A.vdims + B.vdims)
  def _{——}div_{——}(A, B):
    return Dim(A.scalar // B.scalar, A.vdims − B.vdims)
```

For multiplication, the scalar value is multiplied, and the lists of dynamic shapes are combined; and for division, the scalar value is divided and the dynamic shapes are removed from the list:

Dim(1,[#0])*Dim(2,[#1,#2])=Dim(2,[#0,#1,#2]),

Dim(6,[#0,#1])/Dim(2,[#1])=Dim(3,[#0]).

This can enable processing the dynamic shapes while parsing the neural network.

### Example B

Consider the exemplary reshape operation shown in Table 6.1:

TABLE 6.1

| | |
|---|---|
| input | = [Dim(1, #0), Dim(1, #1), Dim(1, #2), Dim(1, #3)] |
| output | = [−1, input.shape[1], 1000]. |

Since the user provides the static value of 1000, the user probably wants to have explicitly this specified shape. First, the wildcard (−1) dimension can be removed from the desired shape. Next, the product of the input and the product of the output can be computed to obtain the number of elements within the shape, as shown in Table 6.2:

TABLE 6.2

| | | |
|---|---|---|
| ninput | = prod(input) | = Dim(1, [#0, #1, #2, #3]) |
| noutput | = prod(output) | = Dim(1000, [#1]) |

If common dynamic shapes in ninput and noutput are removed, the remaining list of dynamic shapes can be matched to the scalar sizes. For instance, in this example, the dynamic shape #1 is common in ninput and noutput. After the dynamic shape #1 is removed, the remaining list of dynamic shapes include #0, #2, and #3, as shown in Table 7:

TABLE 7

| | |
|---|---|
| ninput | = Dim(1, [#0, #2, #3]) |
| noutput | = Dim(1000, [ ]) |

Next the scalar value of 1000 can be resolved. Since ninput does not have any scalar values that could be used, some of the dynamic shapes need to be resolved. For this, the scalar value, which has been globally stored when parsing the inputs, can be used. Table 8 shows an example.

TABLE 8

global_vdims = {#0: 1, #1: 3, #2: 200, #3: 5}.

Thus, the remaining dynamic shapes can be parsed through. It is checked which one is a pure divider of the remaining 1000. Dynamic shapes whose associated value is 1 can be ignored, as they can't be used for reducing the remaining scalar value. So #0 is ignored, then #2 and #3 are used with 5*200=1000. This means that #2 and #3 are globally removed from the neural network, as the user enforces them to be of sizes 200 and 5, respectively. If there are multiple dynamic shapes that provide suitable scalar values, it is undefined which one will be resolved.

After this step, Dim(1, [#0]) is left as ninput, which then is the number of elements that get put into the wildcard (−1) dimension in output. The results are shown in Table 9.

TABLE 9
output[Dim(1, #0), Dim(1, #1), Dim(1000)] = reshape(input[Dim(1, #0),
Dim(1, #1), Dim(1, #2), Dim(1, #3)], [−1, input.shape[1], 1000]

In contrast, conventional method such as ONNX Runtime can be much more limited. It can require the requested reshape to contain the exact reference to the dynamic symbols. So, if the input would be [Dim(1, #0), Dim(2, #1)] (with the stored reference values #0=7 and #2=5), and it is desired to reshape that to [−1, 10], ONNX can't do that, as it would require [−1, Dim(2, #1)] as input. See OSSI, available at <<github.com/microsoft/onnxruntime/blob/master/onnxruntime/python/tools/symbolic_shape infer.py #L1267>> (last accessed Mar. 3, 2022), the entire contents of which is hereby incorporated by reference. In contrast, embodiments of the present disclosure are capable of identifying that the user expected #2 to be ==5, and therefore can remove #2 from the entire computation graph, as it is constrained by the user input.

Reshape/View operations can sometime result in undefined behavior, for example when multiple dynamic shapes qualify for being resolved. According to some embodiments, this problem can be circumvented by the user by fixing the code using explicit shapes instead of static values, as illustrated in the following example

[−1,3,1000]>>[−1,x.shape[1],x.shape[2]*x.shape[3]].

### Run Time Optimizations

Embodiments of the present disclosure can afford several advantages in implementing dynamic shapes at runtime. For example, shape checks can be done at compile time. In contrast, conventional methods, such as OSSI and ONNXRuntime, implement shape checks at runtime, and thus need to spend execution-time every time a neural network is run. Some advantages according to embodiments of the present disclosure are discussed below.

Shape Checking

One problem with conventional methods is how dynamic shapes are implemented in runtime. In most frameworks, compiler and runtime systems maintain tensor objects that contain a pointer to the data, the data type, and the shape. See DLPack's DLTensor, available at <<github.com/dmlc/dlpack/blob/main/include/dlpack/dlpack.h#L154>> (last accessed Mar. 3, 2022), the entire contents of which are hereby incorporated by reference. In operations with multiple inputs, those systems may further need to validate whether the shapes of the inputs are compatible.

Embodiments of the present disclosure allow for doing the checks already at compile time because different dynamic shapes are mapped to each other, as discussed above. For example, dynamic shapes such as Dim(2, [#0, #1]) are obtained, and then evaluations can occur at compile time to determine whether they are compatible. In contrast, conventional methods, such as Nimble, ONNXRuntime, and DISC, do explicit shape checking at runtime.

### Shape Inference

Conventional methods may need to infer the shapes of new tensors on the fly. For example, consider: C=A+B. It may be necessary to read the shape of A and the shape of B, and apply the broadcasting semantics at runtime. See <<pytorch.org/docs/stable/notes/broadcasting.html#broadcasting-semantics>>, the entire contents of which are hereby incorporated by reference herein.

Embodiments of the present disclosure can allow shape inference at compile time. As the methods do not rely on the input of a particular layer, but on the input of the entire neural network, a global array of dynamic shapes (e.g., the set of global virtual dimension IDs, or vdims) can be used. When a neural network is called, the values for the vdims need to be fetched only once from the input tensors. This can provide some advantages. For example, there is no need to maintain the shapes of all intermediate results, as the size of a tensor doesn't need to be computed as:

size=prod(input.shape),

but can be computed as:

size=5*3*vdims[0],

which is less computation intensive and there is no need to maintain the exact shapes of all tensors at runtime. Instead, it is encoded into the code itself. Thus, there can be less maintenance of runtime information, as no tensor shapes are needed. Only one global array of dynamic shapes is needed. The values in the global array of dynamic shapes vdims only need to be set once. In addition, there is no need to do shape checks during execution, as it can be reliably known that #0 will not change during the execution. Thus, shape checks can be reduced to the beginning of the neural network. Therefore, there can be less computational overhead because of the absence of shape checks and shape inference. In contrast, conventional methods, such as ONNXRuntime, infer the shape when building up the execution graph.

### Static to Dynamic Computation Graph Transformation

Methods according to embodiments of the present disclosure are capable of automatically detecting dynamic shapes of a neural network or scientific computation graph without any user interaction. This is in contrast to conventional methods, which may need explicitly defining which dimensions will be dynamic. Embodiments of the present disclosure can enable finding dynamic shapes in a neural network that have been statically parsed previously, for example by using torch.jit.trace ( . . . ), which returns a TorchScript graph that has fixed static input shapes. A benefit of this is to enable dynamic shapes in static computation graphs without changing the code.

### Computation Graph Reshaping

Methods according to embodiments of the present disclosure are capable of being used to change shapes statically. For example, if the neural network has a parsed input shape [#0, #1, 5, 5]. If the user gives a compile hint that #1 will always be 5, all occurrences of #1 can be changed to 5. This can allow the compiler to apply better optimizations, resulting in better performance. A benefit of this is to enable users to transform a computation graph that has fixed input sizes to any shape they prefer without changing any of their code.

### Dynamic Shape Estimations for Optimizing Code

Conventional compilers do not keep track of the dynamic shapes. In contrast, methods according to embodiments of the present disclosure can have a scalar factor and a list of all dynamic sizes. This can be valuable information for auto-tuning the neural network. While conventional compilers would need to use heuristics to guess what a suitable value could be, methods according to embodiments of the present disclosure can make a much better estimation.

For example, assuming that the following values are used:

global_vdims={#0:3,#1:5},

shape=[Dim(8,[#0,#1])].

The dimension computes to shape[0]=8*vdims[0]*vdims[1]. Thus, it can be known that the dimension is always a multiple of 8. This can be used to improve vectorization of the code. Further, it can be known that #0 was initialized with 3 and #1 with 5. Thus, it can be estimated that 8*3*5=120 is likely a used size for this dimension. As #0 and #1 are dynamic shapes, it may not always be the case that 120 is the size actually used. But the estimate is better than not having any such information.

The codes shown in Table 10 and Table 11 compute output[ . . . ]=input[ . . . ]*3.14159 on an N-dimensional Tensor. The code shown in Table 10 is written in an ISPC-like vector language (a conventional method).

TABLE 10

| | |
|---|---|
| typedef uniform int u_int; | // scalar int |
| typedef varying int v_int; | // vector int |
| typedef varying float v_float; | // vector float |

/** First, one would need to compute the number of elements **/
u_int shape[ ] = {...};
u_int numel = 1;
#pragma unroll
for(u_int i = 0; i < sizeof(shape)/sizeof(u_int); i++)
numel *= shape[i];

| | |
|---|---|
| const u_int vector_length | = programCount; // == 8 for AVX2 |
| const v_int vector_lane | = programIndex; // 0 to 7 |

/** then one can compute how many steps one needs to do. They can be
split into full-vector steps, so one doesn't need to do boundary
checks, and one iteration for remaining elements */

| | |
|---|---|
| const u_int steps | = (numel / vector_length) * vector_length; |
| const u_int remaining | = numel % vector_length; |

```
for (u_int i = 0; i < steps; i += vector_length) {
  v_float in = input[i + vector_lane];
  v_float out = in * 3.14159f;
  output[i + vector_lane] = out;
}
if(remaining < vector_lane) {
  v_float in = input[steps + vector_lane];
  v_float out = in * 3.14159f;
  output[steps + vector_lane] = out;
}
```

This code needs 2 for loops, and an if-statement to cover all elements of the Tensor and to utilize the vectors as good as possible. As the number of dimensions of shape is known, the first loop can be unrolled.

The code shown in Table 11 uses the method according to an embodiment of the present disclosure. The additional information available at compile time can allow removal of the if-statement and simplification of the computation of steps.

TABLE 11

| | |
|---|---|
| typedef uniform int u_int; | // scalar int |
| typedef varying int v_int; | // vector int |
| typedef varying float v_float; | // vector float |

/** no need to compute number of elements as it is already known to be
numel = 8 *
* vdims[0] * vdims[1]; */

| | |
|---|---|
| const u_int vector_length | = programCount; // == 8 for AVX2 |
| const v_int vector_lane | = programIndex; // 0 to 7 |

/** knowing that numel == 8 * vdims[0] * vdims[1] and vector_length == 8,
one can simplify steps from ((8 * vdims[0] * vdims[1] / vector_length) *
* vector_length) to (vdims[0] * vdims[1] * vector_length) */

| | |
|---|---|
| const u_int steps | = vdims[0] * vdims[1] * vector_length; |

```
for(u_int i = 0; i < steps; i += vector_length) {
    v_float in = input[i + vector_lane];
    v_float out = in * 3.14159f;
    output[i + vector_lane] = out;
}
/** knowing that numel is dividable by the vector_length, one can know that
remaining will always be 0, therefore no need to the remaining if-
statement. */
```

On top of this, the method according to the embodiment of the present disclosure can capture heuristic values for the vdims. So, if the low-level compiler supports these, it could hand over this estimate. For example, the NEC NCC compiler supports the “loop_count” (See <<hpc.nec/documents/sdk/pdfs/g2af01e-C++UsersGuide-025.pdf>> page 48, the entire contents of which are hereby incorporated herein), as shown in Table 12:

TABLE 12

#pragma _NEC loop_count(15)
for(u_int i = 0; i < steps; i += vector_length) {
...

This can enable generating better low level code depending on the compiler and target hardware. Depending on the complexity of the neural network, such optimizations can result in as much as 10% or greater performance improvement.

### Low Level Compiler Hints

With conventional methods, different shape arrays are used for each stride present. Even if the values are identical at runtime, the compiler cannot assume this to be the case, resulting in the code shown in Table 13 for a simple 2D copy:

TABLE 13

| | |
|---|---|
| int ishape[ ] | = {...} |
| int oshape[ ] | = {...} |

for(int y = 0; y < ishape[0]; y++)
for(int x = 0; x < ishape[1]; x++)

output[oshape[0] * y + x] = input[ishape[0] * y + x];

According to some embodiments of the present disclosure, an exemplary implementation is shown in Table 14:

TABLE 14

```
for(int y = 0; y < vdims[0]; y++)
  for(int x = 0; x < vdims[1]; x++)
    output[vdims[0] * y + x] = input[vdims[0] * y + x];
```

Compared to conventional methods, only two registers (vdims [0] and vdims [1]) are therefore used instead of three (ishape [0], ishape [1] and oshape [0]). Further, code can be further simplified to that shown in Table 15:

TABLE 15

```
for(int y = 0; y < vdims[0]; y++)
  for(int x = 0; x < vdims[1]; x++)
    idx = vdims[0] * y + x;
      output[idx] = input[idx];
```

which reduces the code by one multiplication and addition in each iteration of the loop. Further, this implies that input and output have the same striding, which can also be considered during the generation of the low level code by adding specific pre-fetch instructions. Depending on the complexity of the neural network, such optimizations can result in as much as 5% or greater performance improvement.

### Layer Merging

It is shown above that the Tile/Repeat operation can produce an output with a multiplied shape. With conventional methods, it may not be possible to merge this operation with any other layer because, at compile time, no shapes are known. Assuming the following code shown in Table 16:

TABLE 16

| | | |
|---|---|---|
| input | = ... | // input.shape = [None, None, None] |

| | | | |
|---|---|---|---|
| tmp | = input * 3.14159 | // tmp.shape | = [None, None, None] |
| output | = Tile(input, [1, 1, 4]) | // output.shape | = [None, None, None] |

With conventional methods, no shape size is known. Therefore, only the following code shown in Table 17 can be generated:

TABLE 17

```
for(a = 0 ... ishape[0], b = 0 ... ishape[1], c = 0 ... ishape[2])
  tmp[a, b, c] = input[a, b, c] * 3.141519
oshape[3] = {ishape[0], ishape[1], ishape[2] * 4};
for(a = 0 ... oshape[0], b = 0 ... oshape[1], c = 0 ... oshape[2])
    output[a, b, c] = input[a, b, c%4]
```

According to some embodiments of the present disclosure, the output.shape can be known to be [Dim(1, #0), Dim(1, #1), Dim(4, #2)]; and therefore a different code, as shown in Table 18, can be produced:

TABLE 18

```
for(a = 0 ... vdims[0], b = 0 ... vdims[1], c = 0 ... vdims[2])
    tmp = input[a, b, c] * 3.141519
    output[a, b, c + 0] = tmp
    output[a, b, c + 1] = tmp
    output[a, b, c + 2] = tmp
  output[a, b, c + 3] = tmp
```

In this example, both loops are merged, and a single register is used for tmp instead of an entire array. Depending on the complexity of the neural network, such optimizations can result in as much as 50% or greater performance improvement and reduction of peak memory consumption. In this example, by 16.7% (totalMemory=(a*b*c)+(a*b*c)+(a*b*c*4), tmpMemory=(a*b*c))

### Reduced Runtime Checks

The dynamic shape approach of conventional methods may need to maintain the shapes of all tensors and to constantly check if they are appropriate for the layer that needs to be executed. Embodiments of the present disclosure enable performing these checks already at compile time, and only need checks once at the very beginning of the neural network. Depending on the complexity of the neural network, such optimizations can result in, for example, 1-2% performance improvement.

Layers with Dynamic Output

Layers, such as the tensorflow.Where function, can produce a dynamic output shape, depending on the number of “True” values fed to the function. See <<www.tensorflow.org/api_docs/python/tf/where>>, the entire disclosure of which is hereby incorporated by reference herein. According to some embodiments of the present disclosure, a new dynamic shape ID can be created and set during runtime. A possible implementation of this layer could be as shown in Table 19:

TABLE 19

| | |
|---|---|
| vdims | = [...] |
| C | = A == B # creates Boolean output |
| indices, sum | = prefix_sum(C) |
| vdims[5] | = sum |
| D | = new Tensor(vdims[5]) |

```
for i in range(len(C)):
  if C[i]:
    D[indices[i]] = i
```

### Exemplary Use Case: Real Time Video Processing

In real time video processing (e.g., applied in SmartCities, Industry 4.0, Augmented Reality, Edge, or similar applications), it may be important to have high performance and the option to dynamically adapt the number of frames that get processed at the same time.

In such applications, AI frameworks such as PyTorch or TensorFlow are usually not used, because their overhead is too high and usually violates the hardware (often only embedded machines) and the strict time constraints. Therefore, the neural networks usually get compiled into standalone neural network libraries that yield in much higher performance. Highest performance is achieved by fixed-size neural network libraries, but they don't allow to adapt the number of processed frames. Dynamic-size neural network libraries suffer from lower performance due to the runtime checks and lower code optimization capabilities.

An advantage provided by embodiments of the present disclosure is that it allows using dynamic-size neural network libraries with performance comparable to fixed-size neural network libraries.

Embodiments of the present disclosure provide methods for compiling a neural network for machine learning with dynamic shapes. Embodiments of the present disclosure also provide devices configured (via computer executable instructions) to execute such methods, and a computer readable medium storing instructions for executing such methods.

During parsing and compilation of the neural network, dynamic shapes are tracked in a symbolic way to not lose the shape changing information of layers throughout the neural network. In some embodiments, dynamic shapes of tensors are represented by a scalar factor and a set of global virtual dimension IDs. The global virtual dimension IDs are unique for the entire neural network.

Using the underlying mechanisms of the layers, it is possible to identify which shapes (e.g., the lengths of the axes) can be dynamic, which dynamic shapes need to be identical (and thus can be merged), and which shapes cannot be dynamic due to the applied operations or structure of the neural network.

Using the global virtual dimension IDs, it is possible to perform shape checks at the compiling stage, thus eliminating or reducing the necessary shape checks at runtime. The set of global virtual dimension IDs is stored and is filled at runtime with dimensions from input data or from layers with dynamic output shape (e.g., “tf.Where”). In some embodiments, the stored shape values from parsing dynamic shapes can be used as a reference point to tweak or auto-tune the implementation of the neural network.

According to some embodiments, the method for compiling a neural network for machine learning with dynamic shapes can include parsing the neural network and building a computation graph using a set of global virtual dimension IDs that define the dynamic shapes of tensors. The method can further include performing shape checks when building the computation graph. In this manner, efficient runtime code can be generated. The runtime code would extract dynamic shapes from input tensors of the neural network. According to some embodiments, the method would allow user hints for replacing dynamic shapes with fixed values. The method can also allow better estimates of the dynamic shapes during auto-tuning the computation graph.

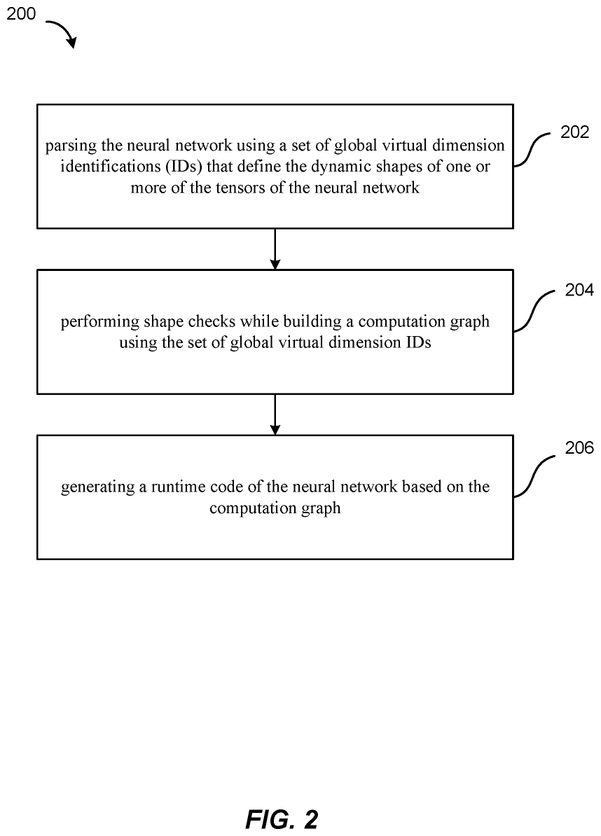

FIG. 2 is a flowchart illustrating a computer-implemented method 200 for compiling a neural network with dynamic shapes for machine learning according to some embodiments.

At 202, the neural network is parsed using a set of global virtual dimension identifications (IDs) that define the dynamic shapes of one or more of the tensors of the neural network.

At 204, shape checks are performed while building a computation graph using the set of global virtual dimension IDs.

At 206, a runtime code of the neural network is generated based on the computation graph.

According to some embodiments, parsing the neural network includes initializing the dynamic shapes of the one or more tensors with the set of global virtual dimension IDs.

According to some embodiments, parsing the neural network further includes precomputing reference values for a subset of the set of global virtual dimension IDs using stored static shapes.

According to some embodiments, the method further includes auto-tuning the neural network based on the reference values. Auto-tuning the neural network can include estimating the dynamic shapes of a subset of the one or more tensors based on the reference values.

According to some embodiments, performing shape checks includes removing a first subset of the set of global virtual dimension IDs from the neural network based on constraints of one or more operations in the computation graph. In some embodiments, values of a second subset of the set of global virtual dimension IDs that have not been removed are to be computed at runtime based on values extracted from input tensors of the neural network or from layers with dynamic output shape. In some embodiments, values of the second subset of the set of global virtual dimension IDs that have not been removed are to be computed at runtime based on values extracted from layers with dynamic output shape.

According to some embodiments, the computation graph includes a tile/repeat operation. In some embodiments, the tile/repeat operation in two or more layers of the neural network can be merged.

According to some embodiments, the computation graph includes a reshape operation.

According to some embodiments, the neural network is configured to perform real time video processing. In some embodiments, the real time video processing can dynamically adapt the number of frames being processed simultaneously.

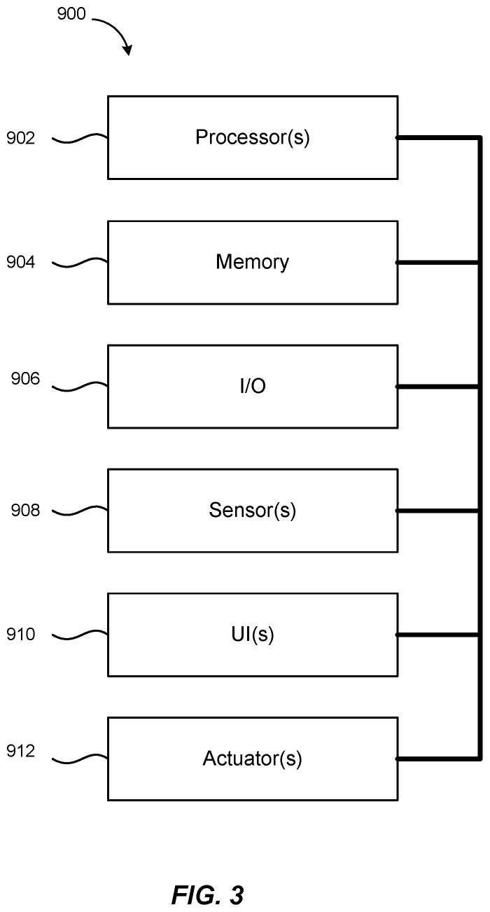

FIG. 3 is a block diagram of an exemplary processing system, which can be configured to perform the methods according to some embodiments.

Referring to FIG. 3, a processing system 900 can include one or more processors 902, memory 904, one or more input/output devices 906, one or more sensors 908, one or more user interfaces 910, and one or more actuators 912. Processing system 900 can be representative of each computing system disclosed herein.

Processors 902 can include one or more distinct processors, each having one or more cores. Each of the distinct processors can have the same or different structure. Processors 902 can include one or more central processing units (CPUs), one or more graphics processing units (GPUs), circuitry (e.g., application specific integrated circuits (ASICs)), digital signal processors (DSPs), and the like. Processors 902 can be mounted to a common substrate or to multiple different substrates.

Processors 902 are configured to perform a certain function, method, or operation (e.g., are configured to provide for performance of a function, method, or operation) at least when one of the one or more of the distinct processors is capable of performing operations embodying the function, method, or operation. Processors 902 can perform operations embodying the function, method, or operation by, for example, executing code (e.g., interpreting scripts) stored on memory 904 and/or trafficking data through one or more ASICs. Processors 902, and thus processing system 900, can be configured to perform, automatically, any and all functions, methods, and operations disclosed herein. Therefore, processing system 900 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 900 can be configured to perform task “X”. Processing system 900 is configured to perform a function, method, or operation at least when processors 902 are configured to do the same.

Memory 904 can include volatile memory, non-volatile memory, and any other medium capable of storing data. Each of the volatile memory, non-volatile memory, and any other type of memory can include multiple different memory devices, located at multiple distinct locations and each having a different structure. Memory 904 can include remotely hosted (e.g., cloud) storage.

Examples of memory 904 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 904.

Input-output devices 906 can include any component for trafficking data such as ports, antennas (i.e., transceivers), printed conductive paths, and the like. Input-output devices 906 can enable wired communication via USB®, DisplayPort®, HDMI®, Ethernet, and the like. Input-output devices 906 can enable electronic, optical, magnetic, and holographic, communication with suitable memory 906. Input-output devices 906 can enable wireless communication via WiFi®, Bluetooth®, cellular (e.g., LTE®, CDMA®, GSM®, WiMax®, NFC®), GPS, and the like. Input-output devices 906 can include wired and/or wireless communication pathways.

Sensors 908 can capture physical measurements of environment and report the same to processors 902. User interface 910 can include displays, physical buttons, speakers, microphones, keyboards, and the like. Actuators 912 can enable processors 902 to control mechanical forces.

Processing system 900 can be distributed. For example, some components of processing system 900 can reside in a remote hosted network service (e.g., a cloud computing environment) while other components of processing system 900 can reside in a local computing system. Processing system 900 can have a modular design where certain modules include a plurality of the features/functions shown in FIG. 9. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for compiling a neural network with tensors having dynamic shapes, the method comprising:
parsing the neural network using a set of global virtual dimension identifications (IDs) that define the dynamic shapes of one or more of the tensors of the neural network;
performing shape checks while building a computation graph using the set of global virtual dimension IDs; and
generating a runtime code of the neural network based on the computation graph.

2. The method of claim 1, wherein parsing the neural network comprises:
initializing the dynamic shapes of the one or more tensors with the set of global virtual dimension IDs.

3. The method of claim 2, wherein parsing the neural network further comprises:
precomputing reference values for a subset of the set of global virtual dimension IDs using stored static shapes.

4. The method of claim 3, further comprising:
auto-tuning the neural network based on the reference values.

5. The method of claim 4, wherein auto-tuning the neural network comprises:
estimating the dynamic shapes of a subset of the one or more tensors based on the reference values.

6. The method of claim 1, wherein performing shape checks comprises:
removing a first subset of the set of global virtual dimension IDs from the neural network based on constraints of one or more operations in the computation graph.

7. The method of claim 6, wherein values of a second subset of the set of global virtual dimension IDs that have not been removed are to be computed at runtime based on values extracted from input tensors of the neural network or from layers with dynamic output shape.

8. The method of claim 6, wherein values of a second subset of the set of global virtual dimension IDs that have not been removed are to be computed at runtime based on values extracted from layers with dynamic output shape.

9. The method of claim 1, wherein the computation graph comprises a tile/repeat operation.

10. The method of claim 9, further comprising:
merging the tile/repeat operation in two or more layers of the neural network.

11. The method of claim 1, wherein the computation graph comprises a reshape operation.

12. The method of claim 1, wherein the neural network is configured to perform real time video processing.

13. The method of claim 12, wherein the real time video processing dynamically adapts the number of frames being processed simultaneously.

14. A system for compiling a neural network with tensors having dynamic shapes, the system comprising one or more hardware processors which, alone or in combination, are configured to provide for execution of the following steps:
parsing the neural network using a set of global virtual dimension identifications (IDs) that define the dynamic shapes of one or more of the tensors of the neural network;
performing shape checks while building a computation graph using the set of global virtual dimension IDs; and
generating a runtime code of the neural network based on the computation graph.

15. A tangible, non-transitory computer-readable medium having instructions thereon which, upon being executed by one or more hardware processors, alone or in combination, provide for execution of the method of claim 1.
